(19) United States
(12) Patent Application Publication
(10) Pub. No.: US 2026/0138777 A1
(43) Pub. Date: May 21, 2026

(54) TRAY WITH ATTACHMENT FEATURES

(71) Applicant: Graphic Packaging International, LLC, Atlanta, GA (US)

(72) Inventor: Liam Cooke, Leicestershire (GB)

(21) Appl. No.: 19/394,010

(22) Filed: Nov. 19, 2025

Related U.S. Application Data
(60) Provisional application No. 63/722,283, filed on Nov. 19, 2024.

(51) Int. Cl. B65D 5/50; B31B 50/26; B31B 105/00; B65D 5/20

(52) U.S. Cl. CPC B65D 5/5038; B31B 50/26; B65D 5/2095; B31B 2105/00

(57) ABSTRACT

A tray construct for holding one or more food products includes a base construct comprising a plurality of panels and a plurality of end flaps foldably connected to a respective panel of the plurality of panels. The tray construct may comprise a crown construct comprising a plurality of panels extending at least partially around an interior of the base construct. The tray construct may comprise attachment features disposed in the crown construct at least partially defined along the upper construct for at least partially engaging a removable tray. The attachment features may comprise one or more notches at least partially formed along a free edge of a respective end flap of the plurality of end flaps. A removable tray may be at least partially received in the interior of the base construct and may engage the attachment features.

### CROSS-REFERENCE TO RELATED APPLICATION

The present application claims priority to U.S. Provisional Patent Application No. 63/722,283 entitled “TRAY WITH ATTACHMENT FEATURES” filed Nov. 19, 2024.

### INCORPORATION BY REFERENCE

The disclosure of U.S. Provisional Patent Application No. 63/722,283 entitled “TRAY WITH ATTACHMENT FEATURES” filed Nov. 19, 2024, is hereby incorporated by reference for all purposes as if presented herein in its entirety.

### TECHNICAL FIELD

The disclosure relates to blanks for forming trays, trays formed therefrom, and methods for forming trays. In particular, the disclosure pertains to trays with removable compartments.

### BACKGROUND

Packaging systems are widely used across various industries for presenting, serving, storing, and transporting products. Conventional packaging systems typically utilize simple tray designs with fixed compartments or separate containers that lack integrated attachment mechanisms. These systems often rely on loose-fitting inserts or individual containers placed within larger trays without secure engagement features. Traditional tray constructions are formed from single blanks that create basic compartmentalized structures with limited configurability. Other multi-compartment food service containers commonly employ separate components that rest freely within primary containers without mechanical attachment systems. These conventional approaches provide minimal structural integration between different tray levels or compartments. Standard paperboard tray manufacturing processes typically produce fixed-geometry containers that cannot accommodate varying product separation requirements or customizable positioning options.

These conventional systems present several technical challenges in food service applications. Loose containers within primary trays can shift during transport, causing spillage between compartments. Inadequate separation between different food products leads to cross-contamination of flavors and textures. Standard tray designs provide insufficient vertical clearance for accommodating varying product heights or volumes.

### SUMMARY

In some embodiments, a tray construct for holding one or more food products may comprise a removable tray construct comprising a primary panel and a plurality of peripheral panels foldably connected to the primary panel defining an interior of the removable tray construct. The tray construct may comprise a base construct comprising a central panel and a plurality of side panels foldably connected to the central panel defining an interior of the base construct. The tray construct may comprise a crown construct comprising a crown rim panel extending at least partially around a perimeter of the crown construct. The crown construct may comprise a plurality of interior panels foldably connected to the crown rim panel. The crown construct may comprise attachment features defined within at least two of the interior panels and arranged to at least partially receive the removable tray. The crown construct may be at least partially received within the interior of the base construct such that at least one of the plurality of interior panels may be in face to face alignment with a respective side panel of the plurality of side panels. In some embodiments, one or more edges of the plurality of peripheral panels of the removable tray construct may be configured to engage with one or more edges of the at least two interior panels to maintain a position of the removable tray construct.

In various embodiments, the attachment features may be configured to generate haptic feedback when the one or more edges of the plurality of peripheral panels of the removable tray are engaged with the one or more edges of the at least two interior panels. In some embodiments, the haptic feedback may include an audible click. In various embodiments, the one or more edges of the at least two interior panels may be at oblique angles with regard to the crown rim panel. In some embodiments, when the removable tray construct is at least partially received by the attachment features the removable tray construct may be at least partially suspended above the central panel of the base construct. In various embodiments, the peripheral panels of the removable tray construct may extend obliquely from the primary panel. In some embodiments, the plurality of side panels may extend obliquely from the central panel. In various embodiments, the removable tray construct may be configured to be at least partially received in the interior of the base construct and configured to frictionally engage the base construct such that respective surfaces thereof may contact one another and resist relative movement therebetween when engaged.

In some embodiments, a set of blanks for forming a tray construct for holding one or more food products may comprise a first blank for forming a removable tray construct comprising a primary panel and a plurality of peripheral panels foldably connected to the primary panel defining an interior of the removable tray construct. The set may comprise a second blank for forming a base construct including a central panel and a plurality of side panels foldably connected to the central panel defining an interior of the base construct. The set may comprise a third blank for forming a crown construct comprising a crown rim panel extending at least partially around a perimeter of the crown construct. The crown construct may comprise a plurality of interior panels foldably connected to the crown rim panel. The crown construct may comprise attachment features defined within at least two of the interior panels and arranged to at least partially receive the removable tray. The crown construct may be configured to be at least partially received within the interior of the base construct such that at least one of the plurality of interior panels may be in face to face alignment with a respective side panel of the plurality of side panels. In various embodiments, one or more edges of the plurality of peripheral panels of the removable tray construct may be configured to engage with one or more edges of at least two of the plurality of interior panels to maintain a position of the removable tray construct in the set of blanks.

In some embodiments, the attachment features may be configured to generate haptic feedback when the one or more edges of the plurality of peripheral panels of the removable tray construct are engaged with the one or more edges of at least two of the plurality of interior panels. In various embodiments, the haptic feedback may include an audible click. In some embodiments, the one or more edges of at least two of the plurality of interior panels may be at oblique angles with regard to the crown rim panel. In various embodiments, when the removable tray construct is at least partially received by the attachment features, the removable tray construct may be at least partially suspended above the central panel of the base construct. In some embodiments, the plurality of peripheral panels of the removable tray construct may extend obliquely from the primary panel. In various embodiments, the plurality of side panels of the base construct may extend obliquely from the central panel. In some embodiments, the removable tray construct may be configured to be at least partially received in the interior of the base construct and configured to frictionally engage the base construct such that respective surfaces thereof may contact one another and resist relative movement therebetween when engaged.

In some embodiments, a method of forming a tray construct may comprise forming a removable tray construct from a first blank, the removable tray construct comprising a primary panel and a plurality of peripheral panels foldably connected to the primary panel defining an interior of the removable tray construct. The method may comprise forming a base construct from a second blank, the base construct comprising a central panel and a plurality of side panels foldably connected to the central panel defining an interior of the base construct. The method may comprise forming a crown construct from a third blank, the crown construct comprising a crown rim panel extending at least partially around a perimeter of the crown construct. The crown construct may comprise a plurality of interior panels foldably connected to the crown rim panel. The crown construct may comprise attachment features defined within at least two of the interior panels and arranged to at least partially receive the removable tray. The method may comprise inserting the crown construct at least partially within the interior of the base construct such that at least one of the plurality of interior panels may be in face to face alignment with a respective side panel of the plurality of side panels.

In various embodiments, one or more edges of the plurality of peripheral panels of the removable tray construct may be configured to engage with one or more edges of at least two of the plurality of interior panels to maintain a position of the removable tray construct. In some embodiments, the attachment features may be configured to generate haptic feedback when the one or more edges of the plurality of peripheral panels of the removable tray construct are engaged with the one or more edges of at least two of the plurality of interior panels. In various embodiments, the haptic feedback may include an audible click. In some embodiments, the one or more edges of at least two of the plurality of interior panels may be oriented at oblique angles with regard to the crown rim panel. In various embodiments, the removable tray construct may be suspended above the central panel of the base construct when the removable tray construct is at least partially received by the attachment features. In some embodiments, the plurality of peripheral panels of the removable tray construct may extend obliquely from the primary panel. In various embodiments, the plurality of side panels of the base construct may extend obliquely from the central panel. In some embodiments, the removable tray construct may be at least partially received in the interior of the base construct and frictionally engage the base construct such that respective surfaces thereof may contact one another and resist relative movement therebetween when engaged.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

Various aspects and many of the attendant advantages of the subject matter disclosed herein will become more readily appreciated as the same becomes better understood by reference to the following detailed description, when taken in conjunction with the accompanying drawings.

According to common practice, the various features of the drawings discussed below are not necessarily drawn to scale. Dimensions of various features and elements in the drawings may be expanded or reduced to more clearly illustrate the embodiments of the subject matter disclosed herein.

FIG. 1A shows a plan view of a base blank for at least partially forming a tray construct according to an embodiment of the subject matter disclosed herein.

FIG. 1B shows a plan view of a crown blank for at least partially forming a tray construct having an insert for a middle tray according to an embodiment of the subject matter disclosed herein.

FIG. 2 shows an isometric view of a tray construct formed from the base blank of FIG. 1A, the crown blank of FIG. 1B and a removable tray, according to an embodiment of the subject matter disclosed herein.

FIG. 3 shows a plan view of a crown blank for at least partially forming tray construct having an insert for a side tray according to an embodiment of the subject matter disclosed herein.

FIG. 4 shows a plan view of a middle tray blank for at least partially forming a tray construct according to an embodiment of the subject matter disclosed herein.

FIG. 5 shows a plan view of a removable tray blank for at least partially forming a removable tray construct according to an embodiment of the subject matter disclosed herein.

FIG. 6 shows a perspective view of assembled blanks configured to form a tray construct having an insertable middle tray according to an embodiment of the subject matter disclosed herein.

FIG. 7 shows a side-by-side perspective view of the removable tray formed from the blank of FIG. 5 and a corresponding tray assembly shown in FIG. 6 assembled blanks configured to form a tray construct having a removable tray according to an embodiment of the subject matter disclosed herein.

FIGS. 8-13 show partial perspective views of an assembly procedure for a tray construct having a removable tray disposed therein according to an embodiment of the subject matter disclosed herein.

Corresponding parts are designated by corresponding reference numbers throughout the drawings.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

Some embodiments of the present disclosure relate to a tray system comprising multiple interconnected components designed for food service applications. The system may include a removable tray construct comprising a primary panel and a plurality of peripheral panels foldably connected to the primary panel defining an interior of the removable tray construct and may further include a base construct comprising a central panel and a plurality of side panels foldably connected to the central panel defining an interior of the base construct. A crown construct may comprise a crown rim panel extending at least partially around a perimeter of the crown construct, a plurality of interior panels foldably connected to the crown rim panel, and attachment features defined within at least two of the interior panels and arranged to at least partially receive the removable tray. The crown construct may be at least partially received within the interior of the base construct such that at least one of the plurality of interior panels is in face to face alignment with a respective side panel of the plurality of side panels.

According to an embodiment of the subject matter disclosed herein, the system may provide secure mechanical engagement between the primary and removable trays through engagement of one or more edges of panels, frictional contact and/or compression retention. The attachment mechanism may provide tactile (e.g., haptic) and/or audible feedback during assembly, with respective portions of the trays contacting and snapping over one another to produce a clicking sensation that confirms proper engagement.

The attachment features may resist incidental disengagement of the removable tray during normal use and transport. The removable tray may be configured to contain condiments, sides, or other food products that are separate from main food items held in the remainder of the primary tray interior. This compartmentalization may allow food service establishments to provide organized meal presentations while maintaining separation between different food categories throughout the service process.

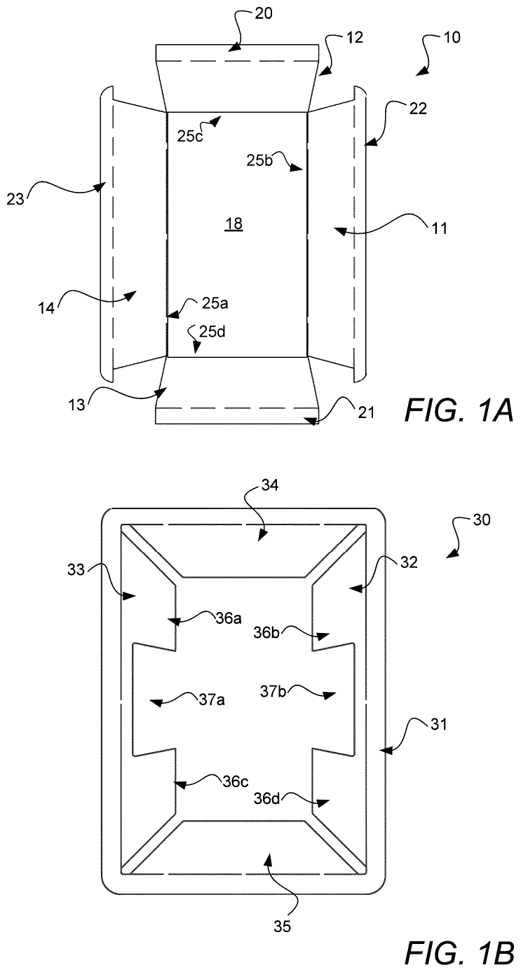

FIG. 1A shows a plan view of a base blank or lower blank 10 for at least partially forming a tray construct according to an embodiment of the subject matter disclosed herein. More specifically, base blank 10 may be used to form a base construct of a first tray. The base blank 10 may comprise a central panel 18 that may form a bottom wall of the tray when assembled. The base blank 10 may further comprise a first side panel 11, a second side panel 12, a third side panel 13, and a fourth side panel 14 that may extend from the central panel 18. Each of the side panels 11, 12, 13, 14 may be foldably connected to the central panel 18 along respective fold lines 25a, 25b, 25c, 25d. The side panels 11, 12, 13, 14 may form sidewalls of the tray when folded upwardly from the central panel 18.

The base blank 10 may further comprise crown flaps 20, 21, 22, 23 that may extend from respective side panels 11, 12, 13, 14. Each crown flap 20, 21, 22, 23 may be foldably connected to its respective side panel along a respective fold line. The crown flaps 20, 21, 22, 23 may be configured to extend outwardly from the side panels when the tray is assembled, thereby forming a rim or flange around the upper perimeter of the tray. The central panel 18 may include angled cuts or notches at its corners to facilitate proper folding and assembly of the base blank 10 into the three-dimensional lower construct.

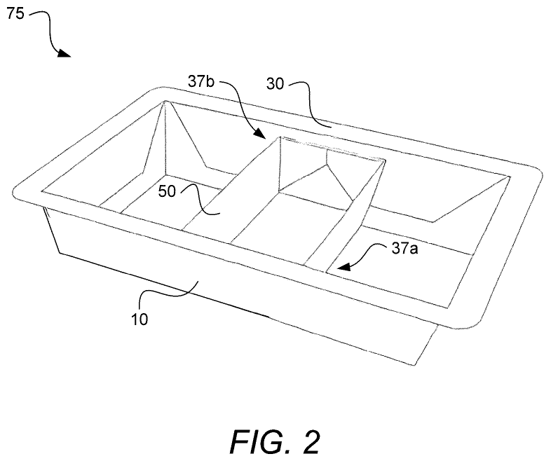

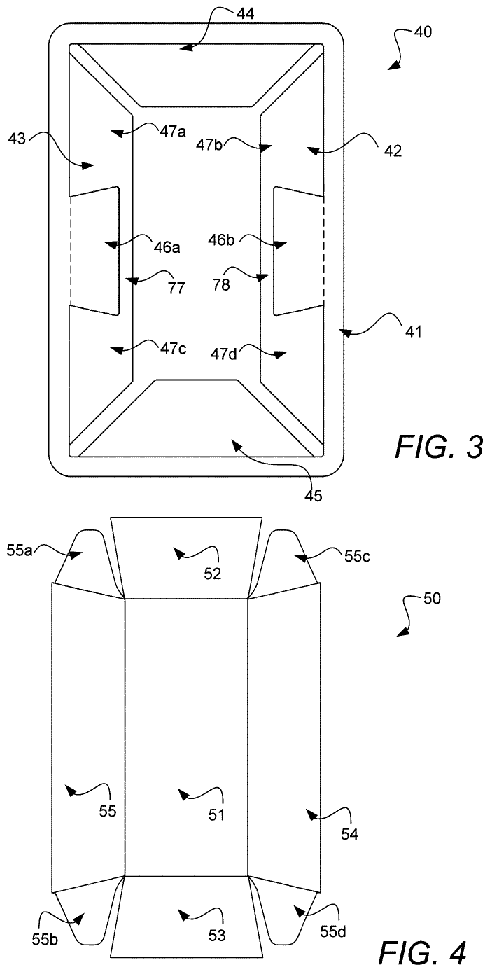

The base blank 10 may be constructed from paperboard or similar material having sufficient rigidity to maintain structural integrity when formed into the tray configuration. The fold lines 25a, 25b, 25c, 25d may be created through scoring, cutting, or other weakening techniques that may facilitate folding along predetermined lines while maintaining material continuity across the fold lines. When base blank 10 is folded into its construct form, it may provide a base tray for receiving a portion of a crown blank 30 or 40 of FIG. 2 or 3 as discussed in more detail below.

FIG. 1B illustrates an exterior surface of a crown blank or upper blank 30 for at least partially forming the first tray in conjunction with the base blank of FIG. 1A according to an embodiment of the subject matter disclosed herein. The crown blank 30 may comprise a crown rim panel 31 that may form an upper portion of the tray sidewalls when assembled. The crown blank 30 may further comprise a plurality of interior panels 32, 33, 34, 35 that may be foldably connected to the crown rim panel 31. Each interior panel 32, 33, 34, 35 may extend from the crown rim panel 31 and may be configured to fold relative to the crown rim panel 31 during assembly of the tray construct. In the embodiments discussed herein, these interior panels 32, 33, 34, 35 fold downward to engage an interior of a construct formed from the base blank 10 of FIG. 1A.

One or more of the interior panels 32, 33, 34, 35 may include attachment portions 36a, 36b, 36c, 36d that are positioned to provide structural support and engagement features when the crown blank 30 may be formed into the upper construct of the overall tray. In some embodiments, the attachment portions 36a, 36b, 36c, 36d may be glued (e.g., by adhesive and the like) in face-to-face arrangement to a respective side panels 11, 12, 13, 14 of the blank 10 of FIG. 1.

The crown blank 30 may further comprise attachment features 37a, 37b that may be defined between two respective attachment portions 36a, 36b, 36c, 36d. That is, attachment feature 37a is defined by space between attachment portions 36a and 36c. Likewise, attachment feature 37b is defined by space between attachment portions 36b and 36d. Further, attachment features 37a, 37b are at least partially defined along free edges (e.g., an edge opposite the fold lines from the crown rim panel 31) of respective interior panels 32, 33, 34, 35. The attachment features 37a, 37b may comprise notches, cutouts or recesses formed in one or more interior panels 32, 33, 34, 35 that may be configured to engage with a removable tray (described below with respect to FIG. 4) when the tray system is assembled.

The attachment features 37a, 37b may be positioned to provide secure mechanical engagement with complementary features of a removable tray. The notches or recesses forming the attachment features 37a, 37b may be dimensioned to create a compression fit with corresponding elements of an engaged removable tray, thereby providing frictional engagement that may resist incidental disengagement. The crown panel 31 may be configured to work in conjunction with a lower construct to form a complete tray assembly, with the attachment features 37a, 37b positioned to enable the removable tray to be at least partially suspended within the interior of the assembled primary tray. Further, the attachment features 37a, 37b are configured to provide enough rigidity to enable an audible and tactile click (e.g., haptic feedback) when a removable tray is engaged.

FIG. 2 illustrates a perspective view of the completed tray 75, according to an embodiment of the subject matter disclosed herein. The tray 75 may comprise a base construct 10 that may form the structural foundation of the assembly. The base construct 10 may include sidewalls that may extend upwardly from a central panel to define the primary interior space of the tray. The sidewalls of the tray 75 may be angled outwardly (e.g., obliquely) to provide a tapered configuration that may facilitate handling and stacking (e.g., nesting) operations.

The tray 75 may further comprise a crown construct 30 that may extend around the upper perimeter of the tray construct 10. The crown construct 30 may provide structural reinforcement to the upper edges of the sidewalls and may serve as an engagement platform for additional components. The crown construct 30 may be formed as part of an upper construct that may work in conjunction with the tray construct 10 to create the complete primary tray assembly.

The tray 75 may include a removable tray 50 that may be positioned within the interior space at least partially defined by the base construct 10 and crown construct 30. The removable tray 50 may be configured to create a separate storage area within the primary tray structure. The removable tray 50 may be at least partially suspended above the central panel of the base construct 10, thereby creating distinct zones for different food products or articles.

The removable tray 50 may engage with attachment features 37a, 37d integrated into the crown construct 30. The engagement may create a secure mechanical connection that may resist incidental disengagement during normal handling and transport operations. The removable tray 50 may be dimensioned to provide adequate storage capacity while maintaining proper fit within the confines of the primary tray structure formed by base 10 and crown construct 30.

The engagement between the one or more edges of the removable tray construct and the attachment features may be achieved through specific geometric configurations that may provide secure mechanical connection. The one or more edges of the peripheral panels 52, 53 of the removable tray construct 50 may be configured with complementary profiles that may interface with corresponding edge geometries of the interior panels 32, 33, 34, 35 of the crown construct 30. The peripheral panels 52, 53 may include edge portions 55a, 55b, 55c, 55d that may extend from the primary panel 51 at predetermined angles to facilitate proper engagement with the attachment features 37a, 37b.

The peripheral panels 52, 53 may be dimensioned to create interference fits with the attachment features 37a, 37b when the removable tray construct 50 may be inserted into the crown construct 30. The peripheral panels 52, 53 may be positioned along opposite sides of the removable tray construct 50 to engage with attachment features 37a, 37b respectively. The peripheral panels 52, 53 may be positioned along the remaining sides of the removable tray construct 50 to provide additional stability and alignment during the engagement process.

The attachment features 37a, 37b may comprise notched configurations that may be formed along free edges of the interior panels 32, 33. The notched configurations may include angled surfaces that may guide the peripheral panels 52, 53 of the removable tray construct 50 during insertion. The angled surfaces may facilitate a camming action that may allow the peripheral panels 52, 53 to deflect the interior panels 32, 34 temporarily before snapping into final engagement positions.

The contact surfaces between the peripheral panels 52, 53 and the attachment features 37a, 37b may be configured to provide frictional engagement that may resist relative movement between the components. The contact surfaces may include textured regions or surface treatments that may enhance the frictional characteristics of the engagement. The dimensional tolerances between the engaging surfaces may be controlled to provide sufficient compression to maintain secure connection while allowing for material variations and manufacturing tolerances.

The one or more edges of the interior panels 32, 34 that may define the attachment features 37a, 37b may be oriented at oblique angles relative to the crown rim panel 31. The oblique orientation may provide enhanced engagement characteristics by creating multiple contact points between the removable tray construct 50 and the crown construct 30. The oblique angles may be selected to optimize the balance between insertion ease and retention strength.

The edge geometries may include beveled or chamfered surfaces that may facilitate alignment during assembly operations. The beveled surfaces may guide the removable tray construct 50 into proper position relative to the attachment features 37a, 37b even when the components may not be perfectly aligned initially. The chamfered surfaces may reduce stress concentrations at the engagement points and may distribute loads more evenly across the contact areas.

The face to face alignment between interior panels and side panels may be achieved through dimensional coordination and positioning mechanisms that may ensure proper structural engagement during assembly. The crown construct 30 may be dimensioned such that when it may be inserted into the interior of the base construct 10, the interior panels 32, 33, 34, 35 may be positioned to contact corresponding side panels 11, 12, 13, 14 in a substantially parallel configuration.

The attachment portions 36a, 36b, 36c, 36d of the interior panels 32, 33, 34, 35 may serve as primary contact surfaces that may engage with the interior surfaces of the side panels 11, 12, 13, 14. These attachment portions 36a, 36b, 36c, 36d may be configured with dimensions that may correspond to the interior dimensions of the base construct 10, thereby creating a complementary fit that may maintain the face to face alignment during assembly and subsequent use.

The oblique angles of the side panels 11, 12, 13, 14 relative to the central panel 18 may provide a tapered interior space that may guide the crown construct 30 into proper position during insertion. The interior panels 32, 33, 34, 35 may be folded at angles that may correspond to the oblique angles of the side panels 11, 12, 13, 14, thereby creating matching angular orientations that may facilitate the face to face alignment.

Adhesive may be applied to one or more of the attachment portions 36a, 36b, 36c, 36d to secure the face to face alignment between the interior panels 32, 33, 34, 35 and the side panels 11, 12, 13, 14. The adhesive application may create a permanent bond that may maintain the structural integrity of the assembled tray construct while preserving the face to face alignment throughout the service life of the product.

The crown rim panel 31 may extend around the perimeter of the crown construct 30 and may be positioned to rest upon the upper edges of the side panels 11, 12, 13, 14 when the crown construct 30 may be fully inserted into the base construct 10. This positioning may provide additional structural support that may help maintain the face to face alignment by preventing lateral movement of the interior panels 32, 33, 34, 35 relative to the side panels 11, 12, 13, 14.

The fold lines connecting the interior panels 32, 33, 34, 35 to the crown rim panel 31 may be positioned at predetermined distances from the fold lines 25a, 25b, 25c, 25d that connect the side panels 11, 12, 13, 14 to the central panel 18. These dimensional relationships may ensure that when both constructs may be assembled, the interior panels 32, 33, 34, 35 may align with the side panels 11, 12, 13, 14 in the face to face configuration without interference or misalignment.

The attachment features 37a, 37b may be positioned between adjacent attachment portions 36a, 36b, 36c, 36d such that they may not interfere with the face to face alignment while still providing the necessary engagement surfaces for the removable tray 50. The spacing and positioning of these attachment features 37a, 37b may be coordinated with the overall dimensional scheme to maintain structural continuity across the face to face aligned surfaces.

During use, the face to face alignment may be maintained through the structural rigidity provided by the paperboard material and the geometric constraints imposed by the assembled configuration. The interior panels 32, 33, 34, 35 may be prevented from moving away from their respective side panels 11, 12, 13, 14 by the presence of the crown rim panel 31 and the overall structural framework of the assembled tray construct.

The face to face alignment may also be maintained during handling and transport operations through the adhesive engagement between the contacting surfaces of the interior panels 32, 33, 34, 35 and side panels 11, 12, 13, 14.

The peripheral panels of the removable tray construct may extend from the primary panel at oblique angles. An oblique angle may be defined as any angle that deviates from perpendicular orientation, specifically angles that may be greater than 90 degrees and less than 180 degrees relative to the primary panel surface. The peripheral panels may extend from the primary panel at oblique angles ranging from approximately 95 degrees to approximately 135 degrees. In some embodiments, the oblique angles may range from approximately 100 degrees to approximately 120 degrees. The oblique angular orientation of the peripheral panels may facilitate insertion and engagement of the removable tray construct within the attachment features of the crown construct.

The side panels of the base construct may similarly extend from the central panel at oblique angles. The side panels may be oriented at oblique angles ranging from approximately 95 degrees to approximately 135 degrees relative to the central panel. In particular embodiments, the side panels may extend at oblique angles of approximately 105 degrees to approximately 115 degrees from the central panel. The oblique orientation of the side panels may provide structural stability to the base construct while accommodating the angular geometry of the crown construct when assembled.

The interior panels of the crown construct may also incorporate oblique angular features. The edges of the interior panels that define the attachment features may be positioned at oblique angles relative to the crown rim panel. These oblique edges may be angled at approximately 100 degrees to approximately 140 degrees relative to the crown rim panel surface. The oblique angular configuration of these edges may facilitate the engagement mechanism with the peripheral panels of the removable tray construct.

The oblique angles of the various panels may work in coordination to create a tapered geometry that may enhance the mechanical engagement between components. The angular relationships may provide progressive compression as the removable tray construct may be inserted into the attachment features. The oblique angles may also contribute to the generation of haptic feedback during assembly by creating controlled deformation and subsequent release of material stress at the engagement points.

The specific angular measurements may vary depending on the material properties and thickness of the paperboard or similar substrate used in construction. Thicker materials may require slightly different oblique angles to achieve optimal engagement characteristics. The oblique angles may be maintained consistently across corresponding panels to ensure proper alignment and engagement of the tray system components during assembly and use.

FIG. 3 illustrates an exterior surface of a crown blank or upper blank 40 for at least partially forming a removable tray in conjunction with the base blank 10 of FIG. 1A according to an embodiment of the subject matter disclosed herein. The crown blank 40 may comprise a crown rim panel 41 that may form a portion of the upper construct when assembled. The crown blank 40 may further comprise a plurality of attachment flaps 42, 43, 44, 45 that may extend from the crown rim panel 41. Each attachment flap 42, 43, 44, 45 may be foldably connected to the crown rim panel 41 along respective fold lines.

Among these attachment flaps 42, 43, 44, 45, the crown blank 40 may include end attachment flaps 44, 45 that extend from opposite ends of the central area. The end attachment flaps 44, 45 may be configured to fold relative to the crown rim panel 41 during assembly of the tray construct. The crown blank 40 may further comprise attachment features 46a, 46b that may be at least partially defined along respective attachment flap fold lines respective of the crown rim panel 41. Attachment feature 46a may include a notch, recess or cutout formed within interior panel 43 and attachment feature 46b may include a corresponding notch, recess or cutout formed within interior panel 42. In this particular embodiment the attachment features 46a, 46b are cutouts that are tapered outward from the crown rim panel towards the central panel and that are fully enclosed by the respective interior panels. That is interior panel 43 includes a closure region 77 at the base of attachment feature 46a and interior panel 42 includes a closure region 78 at the base of attachment feature 46b. The attachment features 46a, 46b may be positioned to flank attachment portions 47a, 47b, 47c, 47d when the crown blank 40 may be formed into the upper construct of the tray.

As discussed herein, the crown blank 40 includes attachment features 47a, 47b, 47c, 47d that may be strategically positioned along the ends of the crown blank 40. The attachment portions 47a, 47b may be located along one end of the crown blank 40, while attachment portions 47c, 47d may be positioned at an opposite end.

The attachment features (e.g., notches) 46a, 46b may be dimensioned to create a compression fit with corresponding elements of a removable tray. The attachment features 46a, 46b may provide frictional engagement of the removable tray that may resist incidental disengagement during handling and transport. The crown rim panel 41 may be configured to work in conjunction with a lower construct to form a complete tray assembly, with the attachment features 46a, 46b positioned to enable a removable tray to be at least partially suspended within the interior of the assembled primary tray.

FIG. 4 illustrates a blank 50 for at least partially forming a removable tray according to an embodiment of the subject matter disclosed herein. In this first embodiment of a removable tray, the removable tray formed by the blank 50 bay be paired with a construct formed by the blanks 10 and 30 of FIGS. 1 and 2. The blank 50 may comprise a primary panel 51 that may form a bottom wall of the removable tray when assembled. The blank 50 may further comprise a first end peripheral panel 52 and a second end peripheral panel 53 that may extend from opposite ends of the primary panel 51. The blank 50 may also comprise a first long peripheral panel 54 and a second long peripheral panel 55 that may extend from opposite sides of the bottom panel 51. Each of the peripheral panels 52, 53, 54, 55 may be foldably connected to the primary panel 51 along respective fold lines.

The blank 50 may further comprise attachment flaps 55a, 55b, 55c, 55d that may extend from respective corners of the blank 50. The attachment flaps 55a, 55b may extend from corners adjacent to the first long peripheral panel 54, while attachment flaps 55c, 55d may extend from corners adjacent to the second long peripheral panel 55. Each attachment flap 55a, 55b, 55c, 55d may be foldably connected to its respective adjacent panels along fold lines. The attachment flaps 55a, 55b, 55c, 55d may be configured to provide structural support and engagement features when the blank 50 may be formed into the removable tray.

The primary panel 51 may be dimensioned to provide a bottom surface for the removable tray that may be configured to fit within the interior of a first tray. The first end peripheral panel 52 and second end peripheral panel 53 may be configured to form end walls of the removable tray when folded upwardly from the primary panel 51. The first long peripheral panel 54 and second long peripheral panel 55 may be configured to form side walls of the removable tray when folded upwardly from the primary panel 51. The attachment flaps 55a, 55b, 55c, 55d may be positioned to engage (e.g., via an adhesive as but one example) with end peripheral panels 52 and 53 such that the removable tray may be assembled for insertion into the first tray.

The blank 50 may be constructed from paperboard or similar material having sufficient rigidity to maintain structural integrity when formed into the removable tray configuration. The fold lines connecting the panels and attachment flaps may be created through scoring, cutting, or other weakening techniques that may facilitate folding along predetermined lines while maintaining material continuity across the fold lines. The dimensions and proportions of the fourth blank 50 may be configured to enable the formed removable tray to be at least partially received within the interior of the first tray formed from the blanks of FIGS. 1A and 1B.

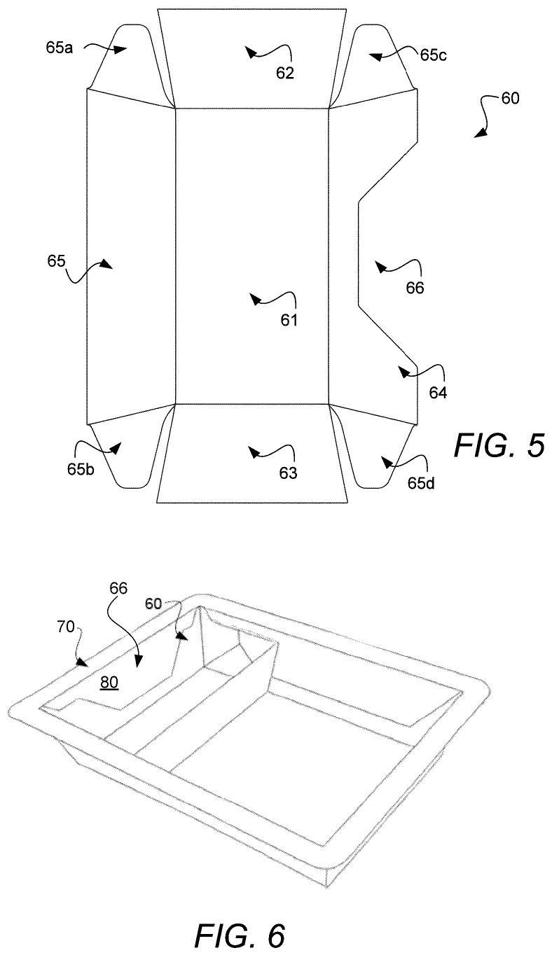

FIG. 5 illustrates a blank 60 for at least partially forming a second embodiment of a removable tray according to an embodiment of the subject matter disclosed herein. In this second embodiment of a removable tray, the removable tray formed by the blank 60 bay be paired with a corresponding tray, as described in more detail below. The blank 60 may comprise a primary panel 61 that may form a bottom wall of the removable tray when assembled. The blank 60 may further comprise a plurality of peripheral panels that may extend from the primary panel 61 to form sidewalls when the blank may be folded into a three-dimensional configuration.

The blank 60 may include end flaps 62, 63 that may be foldably connected to the central panel 61. The end flaps 62, 63 may be positioned at opposite ends of the primary panel 61 and may be configured to form end walls of the removable tray when folded upwardly during assembly. The blank 60 may further comprise a first long peripheral flap 64 and a second long peripheral flap 65 that may extend from opposite sides of the primary panel 61. Each peripheral flap 64, 65 may be foldably connected to the bottom panel 61 along respective fold lines that may facilitate proper folding during assembly of the third tray.

The blank 60 may further comprise corner flaps 65a, 65b, 65c, 65d that may extend from respective corners of the blank. The corner flaps 65a, 65b may be positioned at corners adjacent to the first peripheral flap 64, while corner flaps 65c, 65d may be positioned at corners adjacent to the second peripheral flap 65. Each corner flap 65a, 65b, 65c, 65d may be foldably connected to its respective adjacent panels along fold lines. The corner flaps 65a, 65b, 65c, 65d may be configured to provide structural support (e.g., via adhesive or other attachment means) when the blank 60 may be formed into the removable tray.

The blank 60 may include an engagement feature 66 that may be integrated into the blank structure. The engagement feature 66 may be positioned to provide additional structural integrity or engagement capability with the tray assembly. The primary panel 61 may be dimensioned to provide a bottom surface for the removable tray that may be configured to fit within the interior of a tray described in more detail below. The side flaps 64, 65 may be configured to form side walls of the third tray when folded upwardly from the central panel 61 and the engagement feature 66 may engage one end of the first tray (e.g., end flap 44 of the crown blank 40). The engagement may occur through complementary geometric features that may create a compression fit between the third tray and the attachment features of the first tray. The blank 60 may be constructed from paperboard or similar material having sufficient rigidity to maintain structural integrity when formed into the third tray configuration.

FIG. 6 illustrates a perspective view of the removable tray construct 60 received within a corresponding tray assembly 70 formed from a base construct and a crown construct, according to embodiments of the disclosure. As shown in FIG. 6, removable tray construct 60 includes an engagement feature 66 that engages with an interior side panel 80 of the crown construct for improved retention of the removable tray construct 60.

In some embodiments a tray construct may be configured to receive one, two, three or more removable trays. For example, in some embodiments a removable tray may be received on either end of the tray assembly and in another embodiments two removable trays may be received in a central region of the tray assembly. These and other configurations are within the scope of this disclosure.

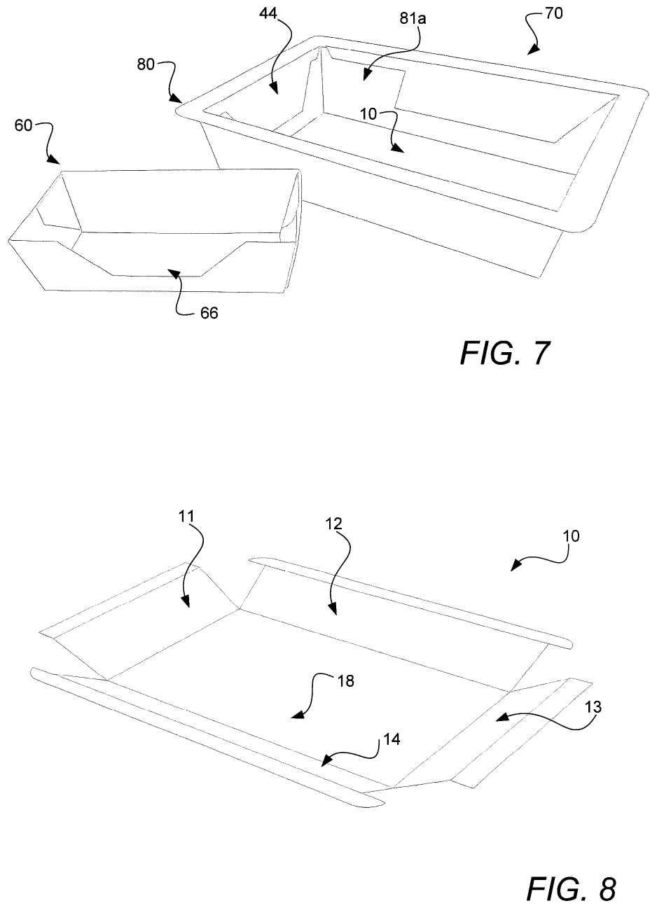

FIG. 7 illustrates a side-by-side perspective view of the removable tray 60 formed from the blank of FIG. 5 and the corresponding tray assembly 70 shown in FIG. 6. The tray assembly 70 may comprise a base construct 10 that may be formed from the base blank of FIG. 1A. The tray assembly 70 may further comprise an upper construct 80 that may be formed similar to the crown blank of FIG. 3. The crown construct 80 may be positioned to work in conjunction with the base construct 10 to form the complete tray assembly 70. The upper construct 80 may include attachment features (e.g., 81a) that may be strategically positioned to enable engagement with the removable tray 60.

The removable tray 60 may further comprise an engagement feature 66 that may be defined by a peripheral wall of the removable tray. The engagement feature 66 may be dimensioned to match a cutout 44 in an interior panel of the tray assembly 70.

FIG. 8 illustrates a perspective view of a step in a method of assembling a construct from the blanks of FIGS. 1A, 1B, 2, and 4 according to an embodiment of the subject matter disclosed herein. The method may begin with obtaining a base blank 10 as shown in FIG. 1A. The base blank 10 may be positioned to form the lower construct of the tray system.

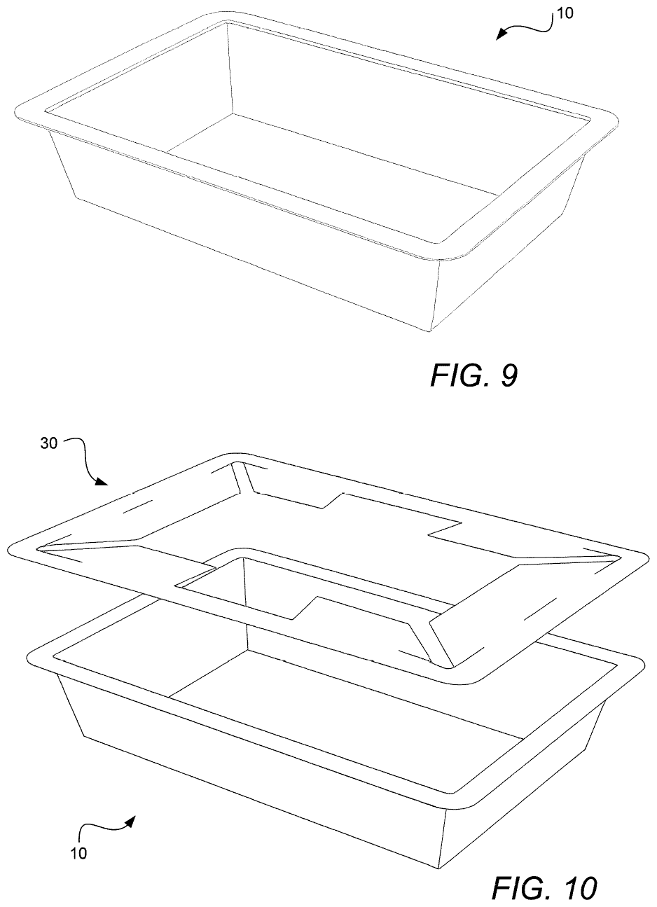

FIG. 9 illustrates a perspective view of the lower construct 10 in another state of assembly according to an embodiment of the subject matter disclosed herein. The lower construct 10 is shown fully assembled wherein a central panel forms a bottom wall of the tray and a plurality of panels extend upwardly from the central panel to form sidewalls of the three-dimensional tray structure. The sidewalls may be angled outwardly from the bottom wall to provide a tapered configuration that may facilitate stacking and nesting of multiple trays during storage and transport.

The lower construct 10 may include a rim or flange that may extend outwardly from the upper edges of the sidewalls. The rim may be formed by crown flaps that may be folded outwardly from the sidewall panels during the assembly process. The lower construct 10 may be formed from a base blank through a series of folding operations that may transform the flat blank into the three-dimensional container configuration shown.

The assembled lower construct 10 may define an interior space that may be configured to receive food products or other articles. The interior space may be dimensioned to accommodate both primary food items and a removable tray that may be at least partially suspended within the interior volume. The bottom wall may provide a stable foundation for the tray system, while the angled sidewalls may facilitate the tray interior. The structural configuration of the lower construct 10 may provide sufficient rigidity to maintain its shape under typical food service loading conditions while remaining lightweight for efficient handling and transport.

FIG. 10 illustrates another perspective view of a step in a method of assembling a construct from the blanks of FIGS. 1A, 1B, 2, and 4 according to an embodiment of the subject matter disclosed herein. This view shows a lower construct 10 positioned below an upper construct 30 that may be configured to be assembled together to form a complete primary tray assembly. The lower construct 10 may comprise the same tray construct as shown in FIG. 9, having a flat bottom panel and sidewalls that may extend upwardly to form a three-dimensional container structure. The lower construct 10 may include a rim or flange that may extend outwardly from the upper edges of the sidewalls to provide structural reinforcement and engagement surfaces for assembly with the upper construct 30.

The upper construct 30 may be positioned above and aligned with the lower construct 10 in the exploded view to demonstrate the assembly relationship between the components. The upper construct 30 may comprise a lid or crown construct that may be designed to fit over or engage with the lower construct 10 during assembly of the primary tray. The upper construct 30 may include cutouts and attachment features that may facilitate interlocking functionality with the lower construct 10. The attachment features of the upper construct 30 may be strategically positioned to enable engagement with removable trays when the primary tray assembly may be completed.

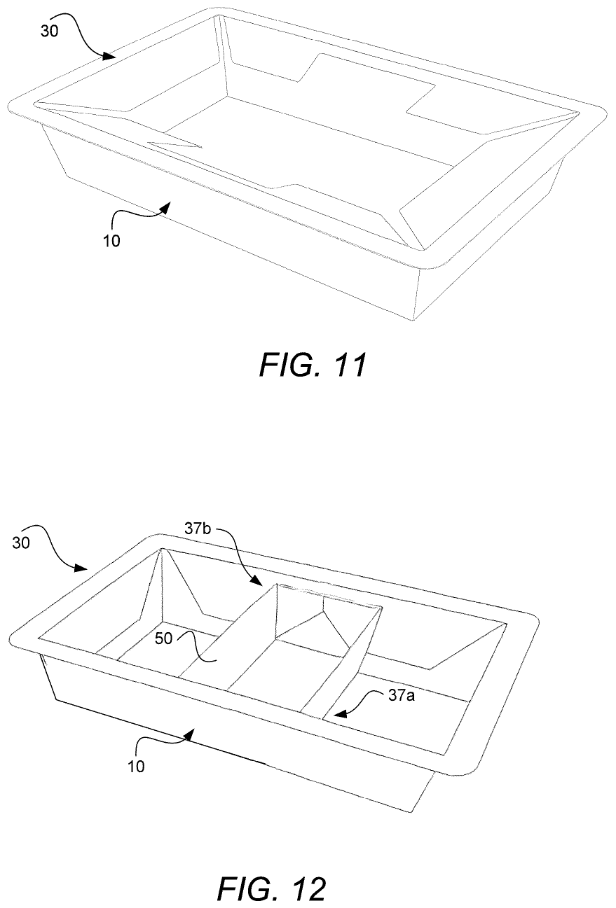

FIG. 11 illustrates another perspective view of a step in a method of assembling a construct from the blanks of FIGS. 1A, 1B, 2, and 4 according to an embodiment of the subject matter disclosed herein. The tray construct may comprise a tray construct 10 now engaged with a crown blank 30. This view illustrates the crown construct 30 panel features being folded downward to engage the interior of the lower construct 10. The tray construct shown in FIG. 11 may represent an intermediate assembly state where the primary structural elements may be combined but may be ready to receive additional components such as removable trays or inserts. The tray construct 10 and crown construct 30 may be formed from separate blanks that may be assembled together, or may represent different functional regions of a single integrated structure.

FIG. 12 illustrates another perspective view a step in a method of assembling a construct from the blanks of FIGS. 1A, 1B, 2, and 4 according to an embodiment of the subject matter disclosed herein. The tray construct may comprise a tray construct 10 now fully engaged crown blank 30 and further shows a removable tray 50. More specifically, removable tray 50 is engaged with attachment features 37a, 37b and suspended from the central panel of the base construct.

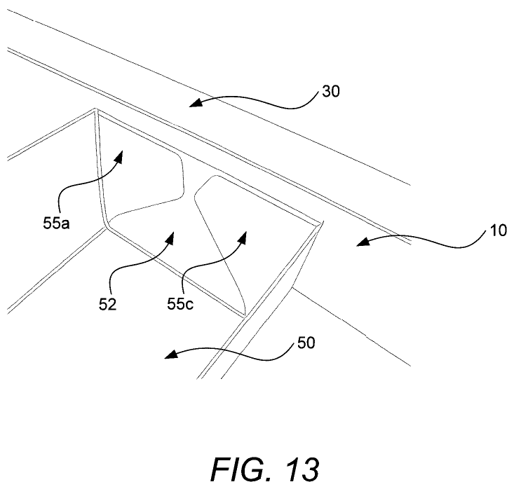

FIG. 13 illustrates a close up perspective view of the tray assembly shown in FIG. 12, according to an embodiment of the subject matter disclosed herein. The removable tray 50 may be formed from the blank of FIG. 4 and may be positioned for insertion into the primary tray assembly. The removable tray 50 may comprise a plurality of panels including side panels and end panels that may form the walls of the removable tray when assembled. The removable tray 50 may include end panels to engage the attachment features of the crown panel 40 as shown.

The assembly method may involve positioning the removable tray 50 such that the end panels of the removable tray 50 may align with corresponding attachment features of the upper construct 30. The removable tray 50 may include an end panel 52 that may provide structural support during the engagement process. The attachment flaps 55a, 55c may adhesively coupled to the end panel 52 to be dimensioned to create a compression fit with the attachment features of the upper construct 30, thereby establishing a secure mechanical connection between the components.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Any of the features of the various embodiments of the disclosure can be combined with replaced by, or otherwise configured with other features of other embodiments of the disclosure without departing from the scope of this disclosure. The carrier styles and panel configurations described above are included by way of example.

In general, the blank may be constructed from paperboard having a caliper so that it is heavier and more rigid than ordinary paper. The blank can also be constructed of other materials, such as cardboard, or any other material having properties suitable for enabling the carrier to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the embodiments, a fold line can be any substantially linear, although not necessarily straight, form of weakening that facilitates folding there along. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

Any of the features of the various embodiments of the disclosure can be combined with, replaced by, or otherwise configured with other features of other embodiments of the disclosure without departing from the scope of this disclosure.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

1. A tray construct for holding one or more food products, the tray construct comprising:
a removable tray construct comprising a primary panel and a plurality of peripheral panels foldably connected to the primary panel defining an interior of the removable tray construct;
a base construct comprising a central panel and a plurality of side panels foldably connected to the central panel defining an interior of the base construct;
a crown construct comprising:
a crown rim panel extending at least partially around a perimeter of the crown construct;
a plurality of interior panels foldably connected to the crown rim panel; and
attachment features defined within at least two of the interior panels and arranged to at least partially receive the removable tray;
wherein the crown construct is at least partially received within the interior of the base construct such that at least one of the plurality of interior panels is in face to face alignment with a respective side panel of the plurality of side panels.

2. The tray construct of claim 1, wherein one or more edges of the plurality of peripheral panels of the removable tray construct are configured to engage with one or more edges of the at least two interior panels to maintain a position of the removable tray construct.

3. The tray construct of claim 2, wherein the attachment features are configured to generate haptic feedback when the one or more edges of the plurality of peripheral panels of the removable tray construct are engaged with the one or more edges of the at least two interior panels.

4. The tray construct of claim 3, wherein the haptic feedback includes an audible click.

5. The tray construct of claim 2, wherein the one or more edges of the at least two interior panels are at oblique angles with regard to the crown rim panel.

6. The tray construct of claim 1, wherein when the removable tray construct is at least partially received by the attachment features the removable tray construct is at least partially suspended above the central panel of the base construct.

7. The tray construct of claim 1, wherein the peripheral panels of the removable tray construct extend obliquely from the primary panel.

8. The tray construct of claim 1, wherein the plurality of side panels extend obliquely from the central panel.

9. The tray construct of claim 1, wherein the removable tray construct is configured to be at least partially received in the interior of the base construct and configured to frictionally engage the base construct such that respective surfaces thereof contact one another and resist relative movement therebetween when engaged.

10. A set of blanks for forming a tray construct for holding one or more food products, the set comprising:
a first blank for forming a removable tray construct comprising a primary panel and a plurality of peripheral panels foldably connected to the primary panel defining an interior of the removable tray construct,
a second blank for forming a base construct including a central panel and a plurality of side panels foldably connected to the central panel defining an interior of the base construct;
a third blank for forming a crown construct comprising:
a crown rim panel extending at least partially around a perimeter of the crown construct;
a plurality of interior panels foldably connected to the crown rim panel; and
attachment features defined within at least two of the interior panels and arranged to at least partially receive the removable tray;
wherein the crown construct is configured to be at least partially received within the interior of the base construct such that at least one of the plurality of interior panels is in face to face alignment with a respective side panel of the plurality of side panels.

11. The set of blanks of claim 10, wherein one or more edges of the plurality of peripheral panels of the removable tray construct are configured to engage with one or more edges of at least two of the plurality of interior panels to maintain a position of the removable tray construct in the set of blanks.

12. The set of blanks of claim 11, wherein the attachment features are configured to generate haptic feedback when the one or more edges of the plurality of peripheral panels of the removable tray construct are engaged with the one or more edges of at least two of the plurality of interior panels.

13. The set of blanks of claim 12, wherein the haptic feedback includes an audible click.

14. The set of blanks of claim 11, wherein the one or more edges of at least two of the plurality of interior panels are at oblique angles with regard to the crown rim panel.

15. The set of blanks of claim 10, wherein when the removable tray construct is at least partially received by the attachment features, the removable tray construct is at least partially suspended above the central panel of the base construct.

16. The set of blanks of claim 10, wherein the plurality of peripheral panels of the removable tray construct extend obliquely from the primary panel.

17. The set of blanks of claim 10, wherein the plurality of side panels of the base construct extend obliquely from the central panel.

18. The set of blanks of claim 10, wherein the removable tray construct is configured to be at least partially received in the interior of the base construct and configured to frictionally engage the base construct such that respective surfaces thereof contact one another and resist relative movement therebetween when engaged.

19. A method of forming a tray construct, the method comprising:
forming a removable tray construct from a first blank, the removable tray construct comprising a primary panel and a plurality of peripheral panels foldably connected to the primary panel defining an interior of the removable tray construct;
forming a base construct from a second blank, the base construct comprising a central panel and a plurality of side panels foldably connected to the central panel defining an interior of the base construct;
forming a crown construct from a third blank, the crown construct comprising:
a crown rim panel extending at least partially around a perimeter of the crown construct;
a plurality of interior panels foldably connected to the crown rim panel; and
attachment features defined within at least two of the interior panels and arranged to at least partially receive the removable tray;
inserting the crown construct at least partially within the interior of the base construct such that at least one of the plurality of interior panels is in face to face alignment with a respective side panel of the plurality of side panels.

20. The method of claim 19, wherein one or more edges of the plurality of peripheral panels of the removable tray construct are configured to engage with one or more edges of at least two of the plurality of interior panels to maintain a position of the removable tray construct.

21. The method of claim 20, wherein the attachment features are configured to generate haptic feedback when the one or more edges of the plurality of peripheral panels of the removable tray construct are engaged with the one or more edges of at least two of the plurality of interior panels.

22. The method of claim 21, wherein the haptic feedback includes an audible click.

23. The method of claim 20, wherein the one or more edges of at least two of the plurality of interior panels are oriented at oblique angles with regard to the crown rim panel.

24. The method of claim 19, wherein the removable tray construct is suspended above the central panel of the base construct when the removable tray construct is at least partially received by the attachment features.

25. The method of claim 19, wherein the plurality of peripheral panels of the removable tray construct extend obliquely from the primary panel.

26. The method of claim 19, wherein the plurality of side panels of the base construct extend obliquely from the central panel.

27. The method of claim 19, wherein the removable tray construct is at least partially received in the interior of the base construct and frictionally engages the base construct such that respective surfaces thereof contact one another and resist relative movement therebetween when engaged.
